(19) United States
(12) Patent Application Publication
(10) Pub. No.: US 2026/0244241 A1
(43) Pub. Date: Aug. 20, 2026

(54) PROTECTIVE CASE FOR ELECTRONIC DEVICE AND KEYBOARD

(71) Applicant: DONGGUAN XUNMIN ELECTRONIC TECHNOLOGY CO., LTD., Dongguan City (CN)

(72) Inventor: JING CAI, Dongguan City (CN)

(73) Assignee: DONGGUAN XUNMIN ELECTRONIC TECHNOLOGY CO., LTD., Dongguan City (CN)

(21) Appl. No.: 19/642,572

(22) Filed: Apr. 8, 2026

(30) Foreign Application Priority Data
Apr. 30, 2025 (CN) 202520860172.X

(51) Int. Cl. G06F 1/16

(52) U.S. Cl. CPC G06F 1/1628; G06F 1/1629; G06F 1/1635; G06F 1/166; G06F 2200/1639

(57) ABSTRACT

The present application provides a protective case for an electronic device and a keyboard. The housing is provided with a receiving groove configured to receive the electronic device; a movable arm is movably connected to the housing; a conductive member is integrated with the housing and the movable arm in a single monolithic piece, the conductive member can be built in the housing and the movable arm, or externally provided on the housing and the movable arm; the conductive member is provided with a first conductive end and a second conductive end; the first conductive end is provided on the housing and configured to be electrically connected to an external object; the second conductive end is provided on the movable arm and can be electrically connected to or disconnected from the electronic device with the movement of the movable arm.

### CROSS-REFERENCE TO RELATED APPLICATIONS

The present application claims priority to Chinese patent application No. 202520860172.X, filed on April 30, 2025, the entire contents of which are incorporated herein by reference.

### TECHNICAL FIELD

The present application relates to the technical field of keyboards, in particular to a protective case for an electronic device and a keyboard.

### BACKGROUND

With the development of science and technology, keyboards are widely used in people's daily lives and serve electronic devices. A protective case for an electronic device, as a component of a keyboard, is used to protect the electronic device. In the related art, an existing protective case for an electronic device includes a housing which is provided with a receiving groove for accommodating the electronic device. However, it can only support the electronic device and cannot achieve electrical conduction with an external object, resulting in poor electrical conduction performance of the existing protective case for the electronic device.

### SUMMARY

The purpose of the present application is to provide a protective case for an electronic device and a keyboard. The housing is provided with a receiving groove configured to receive the electronic device; a movable arm is movably connected to the housing; a conductive member is integrated with the housing and the movable arm in a single monolithic piece, the conductive member can be built in the housing and the movable arm, or externally provided on the housing and the movable arm; the conductive member is provided with a first conductive end and a second conductive end; the first conductive end is provided on the housing and configured to be electrically connected to an external object; the second conductive end is provided on the movable arm and can be electrically connected to or disconnected from the electronic device with the movement of the movable arm, such that the second conductive end can be electrically connected to the electronic device in the receiving groove and the external object through the conductive member. The conductive member fully utilizes the structures of the movable arm and the housing, avoiding the problem that the protective case can only support the electronic device but cannot achieve electrical conduction with an external object, improving the electrical conduction performance of the protective case for the electronic device, and further realizing the wired connection between the electronic device and the external object.

To achieve the above purpose, the present application provides the following technical solution: A protective case for an electronic device, adapted for a keyboard, including: a housing, provided with a receiving groove, wherein the receiving groove is configured to receive the electronic device; a movable arm, movably connected to the housing; and a conductive member, integrated with the housing and the movable arm; wherein the conductive member is built in the housing and the movable arm, or externally provided on the housing and the movable arm; wherein the conductive member is provided with a first conductive end and a second conductive end, the first conductive end is provided on the housing and configured to be electrically connected to an external object, and the second conductive end is provided on the movable arm, and the second conductive end is electrically connected to or disconnected from the electronic device with a movement of the movable arm.

In one embodiment, the conductive member is further provided with a conductive portion for passing through the housing and the movable arm and being built in the housing and the movable arm; and two ends of the conductive portion are electrically connected to the first conductive end and the second conductive end respectively.

In one embodiment, the conductive portion is at least one of a conductive wire, a flexible printed circuit board and a flexible conductive sheet.

In one embodiment, when the movable arm moves relative to the housing, a position of a part of the conductive portion corresponding to the movable arm is adjusted with the movement of the movable arm and maintain an electrical connection state with the second conductive end.

In one embodiment, the movable arm is flexibly connected to the housing and is swingable relative to the housing, and the movable arm and the housing are integrated in a single monolithic piece; or, the movable arm is pivotably connected to the housing and is swingable relative to the housing, the movable arm is connected to the housing through a swinging member, and the swinging member is at least one of a hinge and an articulation member.

In one embodiment, the second conductive end is connected to the movable arm and exposed on an outer side of the movable arm, and the second conductive end is configured to be interfaced with an interface end of the electronic device.

In one embodiment, the first conductive end is connected to the housing and exposed on an outer side of the housing, the first conductive end is configured to interface with an interface end of the external object; the external object is a keyboard main body or an external board with integrated electrical energy; and an interface structure between the first conductive end and the interface end of the external object is a contact-type interface structure or a wireless interface structure.

In one embodiment, when the second conductive end is electrically connected to the electronic device and the first conductive end is electrically connected to the external object, the electronic device is electrically connected to the external object, and data transmission or power supply is performed between the electronic device and the external object.

In one embodiment, the housing includes a first plate and at least one side plate, the receiving groove is defined by the first plate and the at least one side plate in an enclosing manner; and the conductive member is configured to passe through the first plate and the at least one side plate.

To achieve the above purpose, the present application provides the following technical solution: A keyboard, comprising the protective case for the electronic device and a keyboard main body; wherein a lithium battery is built in the keyboard main body, or the keyboard main body is electrically connected to an external power supply; and the keyboard main body is connected to the protective case for the electronic device, and the protective case for the electronic device is configured to receive the electronic device and electrically connect the electronic device and the keyboard main body.

### BRIEF DESCRIPTIONS OF THE DRAWINGS

To clearly illustrate the technical solutions in the embodiments of the present application, a brief description of the accompanying drawings required for describing the embodiments will be given below. Obviously, the accompanying drawings described below are only some embodiments of the present application, and for those skilled in the art, other accompanying drawings can be obtained based on these drawings without exerting creative labor.

For a more complete understanding of the present application and its beneficial effects, the following description will be made with reference to the accompanying drawings. In the following description, the same reference numerals denote the same parts.

FIG. 1 is a schematic diagram showing a movable arm of a protective case for an electronic device swinging outward relative to a housing according to an embodiment of the present application.

FIG. 2 is an enlarged partial view of part A in FIG. 1.

FIG. 3 is a schematic diagram showing another state where the movable arm of the protective case for the electronic device swings outward relative to the housing according to an embodiment of the present application.

FIG. 4 is a schematic diagram showing the movable arm of the protective case for the electronic device swinging inward relative to the housing according to an embodiment of the present application.

FIG. 5 is a schematic diagram showing a conductive member according to an embodiment of the present application.

FIG. 6 is a schematic diagram showing a keyboard according to a second embodiment of the present application.

### Reference Numerals

100: Protective case for an electronic device;

10: Housing; 10a: Receiving groove; 11: First plate; 12: Side plate;

20: Movable arm;

30: Conductive member; 31: First conductive end; 32: Second conductive end; 33: Conductive portion;

200: Keyboard; 210: Keyboard main body

### DETAILED DESCRIPTIONS OF EMBODIMENTS

The following will clearly and completely describe the technical solutions in the embodiments of the present application with reference to the accompanying drawings in the embodiments of the present application. Obviously, the described embodiments are only a part of the embodiments of the present application, rather than all the embodiments. Based on the embodiments in the present application, all other embodiments obtained by those skilled in the art without creative labor shall fall within the protection scope of the present application.

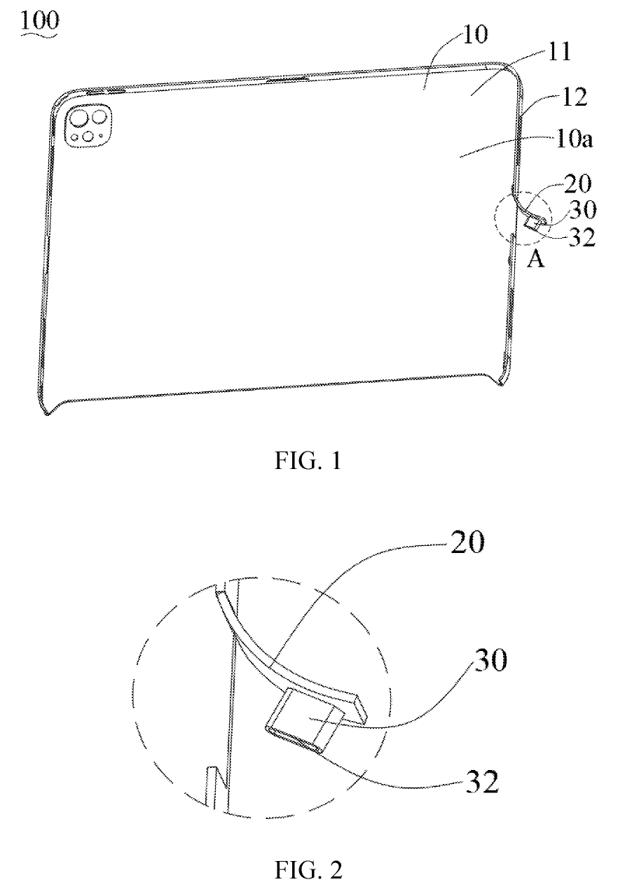

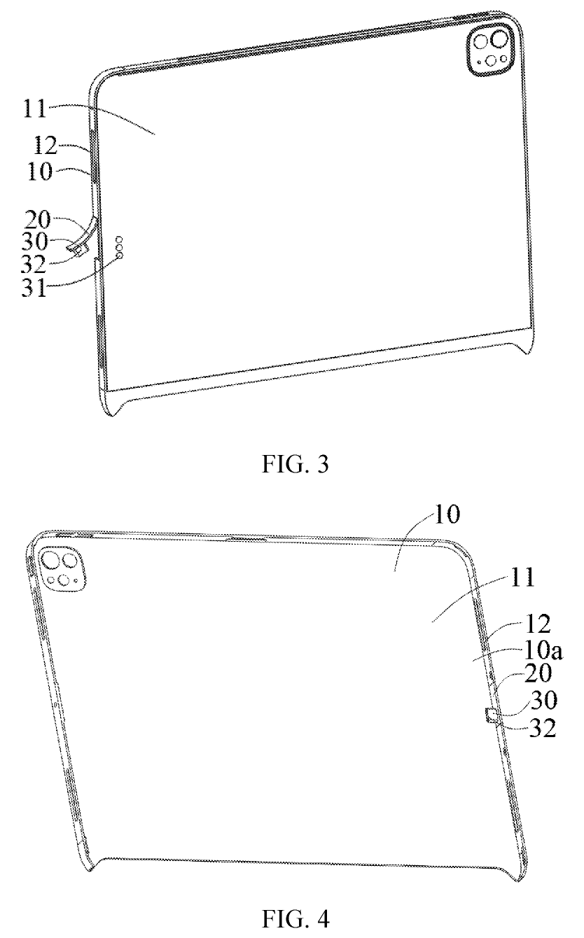

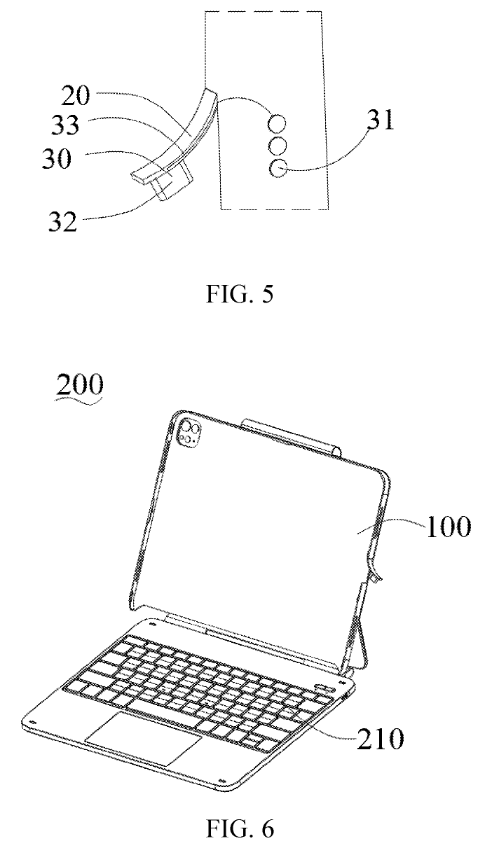

Please refer to FIGS. 1 to 6, an embodiment of the present application provides a protective case 100 for an electronic device. The protective case 100 for the electronic device is adapted for a keyboard 200, and is used to protect the electronic device and achieve electrical conduction between the electronic device and an external object.

Please refer to FIGS. 1 to 6, in this embodiment of the present application, the protective case 100 for the electronic device includes a housing 10, a movable arm 20 and a conductive member 30. The housing 10 is provided with a receiving groove 10a configured to receive the electronic device. The movable arm 20 is movably connected to the housing 10. The conductive member 30 is integrated with the housing 10 and the movable arm 20. The conductive member 30 can be built in the housing 10 and the movable arm 20, or externally provided on the housing 10 and the movable arm 20. The conductive member 30 is provided with a first conductive end 31 and a second conductive end 32. The first conductive end 31 is provided on the housing 10 and configured to be electrically connected to an external object. The second conductive end 32 is provided on the movable arm 20 and can be electrically connected to or disconnected from the electronic device with the movement of the movable arm 20, so that the second conductive end 32 can be electrically connected to the electronic device in the receiving groove 10a and the external object through the conductive member 30. The conductive member 30 fully utilizes the structures of the movable arm 20 and the housing 10, avoiding the problem that the protective case can only support the electronic device but cannot achieve electrical conduction with an external object, improving the electrical conduction performance of the protective case 100 for the electronic device, and further realizing the wired connection between the electronic device and the external object.

Please refer to FIGS. 1 to 6, in this embodiment of the present application, the housing 10 is provided with the receiving groove 10a, which serves as the internal space of the housing 10 and is used to receive the electronic device, such that the electronic device fully utilizes the space of the receiving groove 10a, so that the housing 10 can receive the electronic device through the receiving groove 10a to support the electronic device.

The movable arm 20 is movably connected to the housing 10 to facilitate adjusting the position of the movable arm 20 relative to the housing 10, thereby enabling the movable arm 20 to approach or move away from the electronic device.

The conductive member 30 is integrated with the housing 10 and the movable arm 20, and may be built in or externally provided on the housing 10 and the movable arm 20. The conductive member 30 is provided with a first conductive end 31 and a second conductive end 32. The first conductive end 31 is provided on the housing 10 and configured for electrical connection with an external object, and the second conductive end 32 is provided on the movable arm 20 and can be electrically connected to or disconnected from the electronic device with the movement of the movable arm 20, such that the second conductive end 32 can be electrically connected to the electronic device received in the receiving groove 10a and the external object via the conductive member 30. The conductive member 30 fully utilizes the structures of the movable arm 20 and the housing 10, overcoming the defect that the protective case merely supports the electronic device without enabling electrical conduction with an external object, improving the electrical conduction performance of the protective case 100 for the electronic device, and further achieving wired connection between the electronic device and the external object.

Please refer to FIGS. 1 to 6, in this embodiment of the present application, the conductive member 30 is further provided with a conductive portion 33, which passes through the housing 10 and the movable arm 20 and can be built in the housing 10 and the movable arm 20, such that the conductive portion 33 fully utilizes the internal spaces of the housing 10 and the movable arm 20, so that the housing 10 and the movable arm 20 can protect the conductive portion 33. Two ends of the conductive portion 33 are electrically connected to the first conductive end 31 and the second conductive end 32 respectively, so that the conductive portion 33 can be electrically connected to the external object and the electronic device through the first conductive end 31 and the second conductive end 32 respectively. Thus, the current of the external object can be transmitted to the electronic device sequentially through the first conductive end 31, the conductive portion 33 and the second conductive end 32 to realize the docking between the electronic device and the external object.

Please refer to FIGS. 1 to 6, in this embodiment of the present application, the conductive portion 33 is at least one of a conductive wire, a flexible printed circuit board (FPCB) and a flexible conductive sheet. When the conductive portion 33 is a conductive wire, the external object is electrically connected to the electronic device through the conductive wire, and the conductive wire can deform with the movement of the movable arm 20. When the conductive portion 33 is a flexible printed circuit board, the external object is electrically connected to the electronic device through the flexible printed circuit board, and the flexible printed circuit board can deform with the movement of the movable arm 20. When the conductive portion 33 is a flexible conductive sheet, the external object is electrically connected to the electronic device through the flexible conductive sheet, and the flexible conductive sheet can deform with the movement of the movable arm 20.

Please refer to FIGS. 1 to 6, in this embodiment of the present application, when the movable arm 20 moves relative to the housing 10, the part of the conductive portion 33 corresponding to the movable arm 20 adjusts its position with the movement of the movable arm 20 and maintains an electrical connection state with the second conductive end 32. This ensures the circuit connectivity between the electronic device and the external object, and avoids breakage or poor contact of the conductive portion 33 during the movement of the movable arm 20.

Please refer to FIGS. 1 to 6, in this embodiment of the present application, the movable arm 20 is flexibly connected to the housing 10 and can swing relative to the housing 10, so as to adjust the position of the movable arm 20 relative to the housing 10 and enable the movable arm 20 to approach or separate from the electronic device. The movable arm 20 and the housing 10 are integrated in the single monolithic piece, which improves the connection strength and stability between the movable arm 20 and the housing 10, and avoids breakage between the movable arm 20 and the housing 10 during use.

Alternatively, the movable arm 20 is pivotably connected to the housing 10 and can swing relative to the housing 10, so as to adjust the position of the movable arm 20 relative to the housing 10 and enable the movable arm 20 to approach or separate from the electronic device. The movable arm 20 is connected to the housing 10 through a swinging member, which is at least one of a hinge and an articulation member. When the swinging member is a hinge, two ends of the hinge are respectively connected to the movable arm 20 and the housing 10, so that the movable arm 20 can swing relative to the housing 10 under the action of the hinge to ensure the swinging effect of the movable arm 20. When the swinging member is an articulation member, two ends of the articulation member are respectively connected to the movable arm 20 and the housing 10, so that the movable arm 20 can swing relative to the housing 10 under the action of the articulation member to ensure the swinging effect of the movable arm 20.

Please refer to FIGS. 1 to 6, in this embodiment of the present application, the second conductive end 32 is connected to the movable arm 20 and exposed on the outer side of the movable arm 20, and is configured to be interfaced with the interface end of the electronic device, to facilitate the user to directly dock the second conductive end 32 with the interface end of the electronic device, simplifying the operation process. Meanwhile, it enables quick inspection, maintenance or replacement when a connection failure occurs, improving the operational and maintenance convenience of the second conductive end 32.

Please refer to FIGS. 1 to 6, in this embodiment of the present application, the first conductive end 31 is connected to the housing 10 and exposed on the outer side of the housing 10, and is configured to be interfaced with the interface end of the external object. This allows the interface end of the external object to be directly docked with the first conductive end 31 in the external environment, improving the operational convenience between the interface end of the external object and the first conductive end 31. The external object is a keyboard main body 210 or an external plate integrated with electric energy.

An interface joint structure between the first conductive end 31 and the interface end of the external object is a contact interface joint structure or a wireless interface joint structure. When the interface joint structure is a contact type, it realizes electrical connection through physical contact, improving the stability of electrical conduction performance. Meanwhile, the first conductive end 31 and the interface end of the external object can be directly docked without an additional power supply, simplifying the structure. When the interface joint structure is a wireless type, no physical contact is required, allowing the external object to move within a certain range, improving the flexibility and convenience of the external object. Interfaces and cables are reduced, making the protective case 100 for the electronic device more concise and beautiful.

Please refer to FIGS. 1 to 6, in this embodiment of the present application, when the second conductive end 32 is electrically connected to the electronic device and the first conductive end 31 is electrically connected to the external object, the electronic device is electrically connected to the external object, and data transmission or power supply can be performed between the electronic device and the external object, to realize the electrical conduction effect between the electronic device and the external object, such that the electrical conduction performance of the protective case 100 for the electronic device is improved, and the wired connection between the electronic device and the external object is further achieved.

Please refer to FIGS. 1 to 6, in this embodiment of the present application, the housing 10 includes a first plate 11 and at least one side plate 12. The receiving groove 10a is defined by the first plate 11 and the at least one side plate 12 in an enclosing manner, so that the first plate 11 and the at least one side plate 12 serve as the inner side walls of the receiving groove 10a to support the electronic device, thereby facilitating the detachable connection of the electronic device to the housing 10. Optionally, there are three side plates 12, which are arranged along the peripheral side wall of the electronic device and respectively contact the left side wall, upper side wall and right side wall of the electronic device. The conductive member 30 passes through the first plate 11 and the at least one side plate 12, so that the conductive member 30 fully utilizes the structures of the first plate 11 and the at least one side plate 12, and thus the first plate 11 and the at least one side plate 12 can protect the conductive member 30.

Please refer to FIGS. 1 to 6, in the second embodiment of the present application, a keyboard 200 includes the protective case 100 for an electronic device and a keyboard main body 210. A lithium battery is built in the keyboard main body 210, which enables the keyboard main body 210 to be used anywhere without relying on an external power supply, free from the limitation of power sockets, so as to realize flexible use in different places. Alternatively, the keyboard main body 210 is electrically connected to an external power supply. When the power of the built-in lithium battery of the keyboard main body 210 is insufficient, the external power supply can provide continuous power for the keyboard main body 210, avoiding inability to use due to power exhaustion, ensuring long-term stable operation of the keyboard main body 210 and meeting the user's demand for long-term use.

The keyboard main body 210 is connected to the protective case 100 for the electronic device, which is used to receive the electronic device and electrically connect the electronic device and the keyboard main body 210, so that the keyboard main body 210 can provide instructions and data for the user to operate the electronic device.

At this time, the protective case 100 for the electronic device includes a housing 10, a movable arm 20 and a conductive member 30. The housing 10 is provided with a receiving groove 10a configured to receive the electronic device. The movable arm 20 is movably connected to the housing 10. The conductive member 30 is integrated with the housing 10 and the movable arm 20. The conductive member 30 can be built in the housing 10 and the movable arm 20, or externally provided on the housing 10 and the movable arm 20. The conductive member 30 is provided with a first conductive end 31 and a second conductive end 32. The first conductive end 31 is provided on the housing 10 and configured to be electrically connected to an external object. The second conductive end 32 is provided on the movable arm 20 and can be electrically connected to or disconnected from the electronic device with the movement of the movable arm 20, so that the second conductive end 32 can be electrically connected to the electronic device in the receiving groove 10a and the external object through the conductive member 30. The conductive member 30 fully utilizes the structures of the movable arm 20 and the housing 10, avoiding the problem that the protective case can only support the electronic device but cannot achieve electrical conduction with an external object, improving the electrical conduction performance of the protective case 100 for the electronic device, and further realizing the wired connection between the electronic device and the external object.

### Beneficial Effects of the present application

Compared with the related art, the beneficial effects of the present application are as follows: The present application provides a protective case 100 for an electronic device and a keyboard 200. The housing 10 is provided with a receiving groove 10a configured to receive the electronic device. The movable arm 20 is movably connected to the housing 10. The conductive member 30 is integrated with the housing 10 and the movable arm 20 in a single monolithic piece, the conductive member 30 can be built in or externally provided on the housing 10 and the movable arm 20. The conductive member 30 is provided with a first conductive end 31 and a second conductive end 32. The first conductive end 31 is provided on the housing 10 for electrical connection with an external object. The second conductive end 32 is provided on the movable arm 20 and can be electrically connected to or disconnected from the electronic device with the movement of the movable arm 20, such that the second conductive end 32 can be electrically connected to the electronic device in the receiving groove 10a and the external object through the conductive member 30. The conductive member 30 fully utilizes the structures of the movable arm 20 and the housing 10, avoiding the problem that the protective case can only support the electronic device but cannot achieve electrical conduction with an external object, improving the electrical conduction performance of the protective case 100 for the electronic device, and further realizing the wired connection between the electronic device and the external object.

It should be noted that all directional indicators (such as up, down, left, right, front, rear, ...) in the embodiments of the present application are only used to explain the relative positional relationship and movement state between components in a specific posture. If the specific posture changes, the directional indicators will also change accordingly.

It should also be noted that when an element is referred to as being "fixed on" or "provided on" another element, it can be directly on the other element or there may be an intermediate element at the same time. When an element is referred to as being "connected" to another element, it can be directly connected to the other element or indirectly connected to the other element through an intermediate element.

In addition, the descriptions involving "first", "second", etc. in the present application are only for descriptive purposes, and cannot be understood as indicating or implying their relative importance or implicitly indicating the number of indicated technical features. Thus, the features defined with "first" and "second" may explicitly or implicitly include at least one such feature. In addition, the technical solutions between the various embodiments can be combined with each other, but must be based on the realizability by those of ordinary skill in the art. When the combination of technical solutions is contradictory or cannot be realized, such a combination of technical solutions shall be deemed to not exist and shall not fall within the protection scope claimed by the present application.

The above are only preferred embodiments of the present application, and do not limit the patent scope of the present application. Under the inventive concept of the present application, all equivalent structural transformations made by using the contents of the specification and drawings of the present application, or direct/indirect application in other related technical fields, are included in the patent protection scope of the present application.

What is claimed is:

1. A protective case for an electronic device, adapted for a keyboard, comprising:
a housing, provided with a receiving groove, wherein the receiving groove is configured to receive the electronic device;
a movable arm, movably connected to the housing; and
a conductive member, integrated with the housing and the movable arm;
wherein the conductive member is built in the housing and the movable arm, or externally provided on the housing and the movable arm;
wherein the conductive member is provided with a first conductive end and a second conductive end, the first conductive end is provided on the housing and configured to be electrically connected to an external object; and
the second conductive end is provided on the movable arm, and the second conductive end is electrically connected to or disconnected from the electronic device with a movement of the movable arm.

2. The protective case for the electronic device according to claim 1, wherein the conductive member is further provided with a conductive portion for passing through the housing and the movable arm and being built in the housing and the movable arm; and
two ends of the conductive portion are electrically connected to the first conductive end and the second conductive end respectively.

3. The protective case for the electronic device according to claim 2, wherein the conductive portion is at least one of a conductive wire, a flexible printed circuit board and a flexible conductive sheet.

4. The protective case for the electronic device according to claim 2, wherein when the movable arm moves relative to the housing, a position of a part of the conductive portion corresponding to the movable arm is adjusted with the movement of the movable arm and maintain an electrical connection state with the second conductive end.

5. The protective case for the electronic device according to claim 1, wherein the movable arm is flexibly connected to the housing and is swingable relative to the housing, and the movable arm and the housing are integrated in a single monolithic piece; or,
the movable arm is pivotably connected to the housing and is swingable relative to the housing, the movable arm is connected to the housing through a swinging member, and the swinging member is at least one of a hinge and an articulation member.

6. The protective case for the electronic device according to claim 1, wherein the second conductive end is connected to the movable arm and exposed on an outer side of the movable arm, and the second conductive end is configured to be interfaced with an interface end of the electronic device.

7. The protective case for the electronic device according to claim 1, wherein the first conductive end is connected to the housing and exposed on an outer side of the housing, the first conductive end is configured to interface with an interface end of the external object;
the external object is a keyboard main body or an external board with integrated electrical energy; and
an interface structure between the first conductive end and the interface end of the external object is a contact-type interface structure or a wireless interface structure.

8. The protective case for the electronic device according to claim 1, wherein when the second conductive end is electrically connected to the electronic device and the first conductive end is electrically connected to the external object, the electronic device is electrically connected to the external object, and data transmission or power supply is performed between the electronic device and the external object.

9. The protective case for the electronic device according to claim 1, wherein the housing comprises a first plate and at least one side plate, the receiving groove is defined by the first plate and the at least one side plate in an enclosing manner; and
the conductive member is configured to passe through the first plate and the at least one side plate.

10. A keyboard, comprising the protective case for the electronic device according to claim 1, and a keyboard main body;
wherein a lithium battery is built in the keyboard main body, or the keyboard main body is electrically connected to an external power supply; and
the keyboard main body is connected to the protective case for the electronic device, and the protective case for the electronic device is configured to receive the electronic device and electrically connect the electronic device and the keyboard main body.

11. A protective case for an electronic device, adapted for a keyboard, comprising:
a housing, provided with a receiving groove, wherein the receiving groove is configured to receive the electronic device;
a movable arm, movably connected to the housing; and
a conductive member, integrated with the housing and the movable arm;
wherein the conductive member is provided with a first conductive end and a second conductive end, the first conductive end is provided on the housing and configured to be electrically connected to an external object; and
the second conductive end is provided on the movable arm, and the second conductive end is electrically connected to or disconnected from the electronic device with a movement of the movable arm.

12. The protective case for the electronic device according to claim 11, wherein the movable arm is movably connected to the housing, and the movable arm approaches or moves away from the electronic device.

13. The protective case for the electronic device according to claim 11, wherein a position of the movable arm is adjustable relative to the housing, and a position of the conductive member is adjusted along with a movement of the movable arm; and
the conductive member is electrically connected to the electronic device located in the receiving groove and an external object.

14. The protective case for the electronic device according to claim 11, wherein the movable arm is flexibly connected to the housing and is swingable relative to the housing, and the movable arm and the housing are integrated in a single monolithic piece; or,
the movable arm is pivotably connected to the housing and is swingable relative to the housing, the movable arm is connected to the housing through a swinging member, and the swinging member is at least one of a hinge and an articulation member.

15. The protective case for the electronic device according to claim 11, wherein the conductive member is further provided with a conductive portion for passing through the housing and the movable arm and being built in the housing and the movable arm; and
two ends of the conductive portion are electrically connected to the first conductive end and the second conductive end respectively.

16. The protective case for the electronic device according to claim 15, wherein when the movable arm moves relative to the housing, a position of a part of the conductive portion corresponding to the movable arm is adjusted with the movement of the movable arm and maintain an electrical connection state with the second conductive end.

17. The protective case for the electronic device according to claim 11, wherein the second conductive end is connected to the movable arm and exposed on an outer side of the movable arm, and the second conductive end is configured to be interfaced with an interface end of the electronic device.

18. The protective case for the electronic device according to claim 11, wherein the conductive member is built in the housing and the movable arm, or externally provided on the housing and the movable arm;
the first conductive end is connected to the housing and exposed on an outer side of the housing, the first conductive end is configured to interface with an interface end of the external object;
the external object is a keyboard main body or an external board with integrated electrical energy; and
an interface structure between the first conductive end and the interface end of the external object is a contact-type interface structure or a wireless interface structure.

19. The protective case for the electronic device according to claim 11, wherein when the second conductive end is electrically connected to the electronic device and the first conductive end is electrically connected to the external object, the electronic device is electrically connected to the external object, and data transmission or power supply is performed between the electronic device and the external object.

20. The protective case for the electronic device according to claim 11, wherein the housing comprises a first plate and at least one side plate, the receiving groove is defined by the first plate and the at least one side plate in an enclosing manner; and
the conductive member is configured to passe through the first plate and the at least one side plate.
